(19) United States
(12) Patent Application Publication
(10) Pub. No.: US 2020/0334072 A1
(43) Pub. Date: Oct. 22, 2020

(54) INFORMATION PROCESSING DEVICE, INFORMATION PROCESSING SYSTEM, AND COMPUTER PROGRAM PRODUCT

(71) Applicant: FUJITSU CLIENT COMPUTING LIMITED, Kanagawa (JP)

(72) Inventor: Kei Kato, Kanagawa (JP)

(73) Assignee: FUJITSU CLIENT COMPUTING LIMITED, Kanagawa (JP)

(21) Appl. No.: 16/832,602

(22) Filed: Mar. 27, 2020

(30) Foreign Application Priority Data
Apr. 16, 2019 (JP) 2019-077821
Apr. 16, 2019 (JP) 2019-077822

(51) Int. Cl. G06F 9/48; G06F 9/50; G06N 20/00

(52) U.S. Cl. CPC G06F 9/4843; G06N 20/00; G06F 9/5027

(57) ABSTRACT

An information processing device is connected to a plurality of processors to which one or more of kinds of tasks are allocable. The tasks are for processing data output from a data generator. The information processing device includes a controller that allocates one or more of the tasks to each of the processors based on processability information and throughput information, the processability information representing processability of each of the processors, the throughput information representing throughput for each of the tasks to process the data in a predetermined unit.

### CROSS-REFERENCE TO RELATED APPLICATIONS

This application is based upon and claims the benefit of priority from Japanese Patent Application NO. 2019-077822, filed Apr. 16, 2019 and No. 2019-077821, filed Apr. 16, 2019, the entire contents of which are incorporated herein by reference.

### BACKGROUND

### Technical Field

Embodiments described herein relate generally to an information processing device, an information processing system, and a computer program product.

### Description of the Related Art

Conventionally, it is known that a plurality of processors being hardware shares handling multiple tasks, such as individual artificial intelligence (AI) processes, to process data output from a data generator (for example, image data output from a camera).

However, it is conventionally difficult to appropriately allocate the tasks to the respective processors due to different throughputs depending on the tasks.

It is thus preferable to appropriately and easily allocate tasks to multiple processors to share processing of data output from a data generator.

### SUMMARY

According to one aspect of this disclosure, an information processing device is to be connected to a plurality of processors as hardware to which one or more of a plurality of kinds of tasks are allocable. The kinds of tasks are for processing data output from a data generator. The information processing device includes a controller that allocates one or more of the kinds of tasks to each of the processors on the basis of processability information and throughput information, the processability information representing processability of each of the processors, the throughput information representing throughput for each of the kinds of tasks to process the data in a predetermined unit.

### BRIEF DESCRIPTION OF THE DRAWINGS

FIG. 1 is a schematic diagram illustrating a connection form of a plurality of platforms in an information processing system according to a first embodiment by way of example;

FIG. 2 is a schematic diagram illustrating a hardware configuration of a platform;

FIG. 3 is a diagram illustrating a software configuration of a platform;

FIG. 4 is a schematic diagram illustrating a hardware configuration of a PCIe bridge controller;

FIG. 5 is a diagram illustrating a layer configuration of PCIe;

FIG. 6 is a diagram illustrating how the other processors appear from a processor (processor H);

FIG. 7 is a diagram illustrating how the other processors appear from a processor (processor E);

FIG. 8 is a diagram illustrating a data transfer method among processors through the PCIe bridge controller;

FIG. 9 is a functional block diagram of the information processing system by way of example;

FIG. 10 is a schematic diagram of a retail premise where cameras are installed;

FIG. 11 is a schematic diagram illustrating an exemplary processability table;

FIG. 12 is a schematic diagram illustrating an exemplary throughput table;

FIG. 13 is a schematic diagram illustrating an exemplary first camera information table;

FIG. 14 is a schematic diagram illustrating an exemplary AI processing pattern table;

FIG. 15 is a diagram illustrating a first example of allocation of tasks to the processors B to G;

FIG. 16 is a diagram illustrating a second example of allocation of tasks to the processors B to G;

FIG. 17 is a flowchart illustrating processing by a platform as an information processing device;

FIG. 18 is a flowchart illustrating the process of Step S2 of the flowchart in FIG. 17 in detail by way of example;

FIG. 19 is a schematic diagram illustrating an exemplary second camera information table in a second embodiment; and

FIG. 20 is a flowchart illustrating the process in Step S2 of the flowchart in FIG. 17 in detail by way of example.

### DETAILED DESCRIPTION

Hereinafter, exemplary embodiments (first and second embodiments) of an information processing device, an information processing system, and a computer program product will be described in detail with reference to the accompanying drawings. In the following embodiments, tasks are mainly exemplified by AI processing, however, the tasks are not limited to AI processing.

### First Embodiment

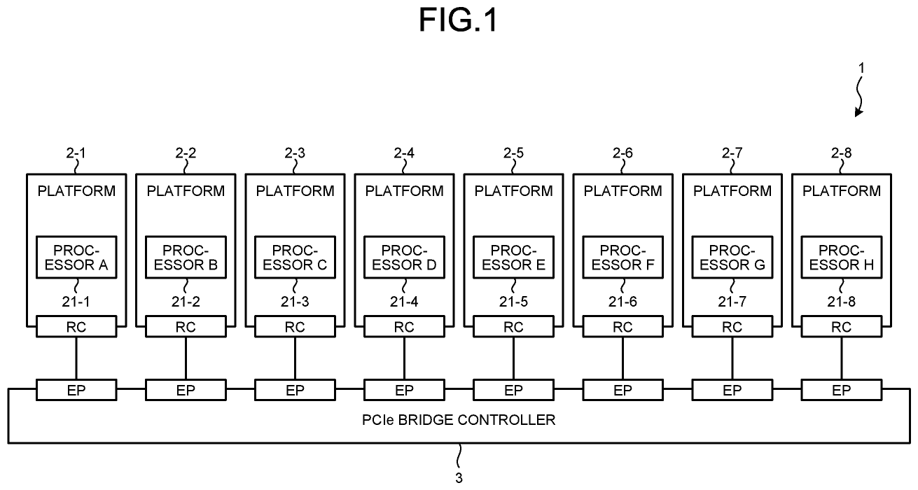

A first embodiment will be described. FIG. 1 is a schematic diagram illustrating a connection form of a plurality of platforms of an information processing system 1 according to the first embodiment.

System Configuration

The information processing system 1 illustrated in FIG. 1 includes a peripheral component interconnect express (PCIe; registered trademark) bridge controller 3 and a plurality of (eight in the example in FIG. 1) platforms 2-1 to 2-8. The platforms 2-1 to 2-8 are connected to the PCIe bridge controller 3.

Hereinafter, the platforms are denoted by reference numerals 2-1 to 2-8 when one of them is to be identified. Any of the platforms or all of the platforms are generally denoted by reference numeral 2.

Platform

The platform 2-1 as an information processing device includes a processor 21-1. Similarly, the platforms 2-2 to 2-8 include processors 21-2 to 21-8, respectively. In the PCIe, the processors 21-1 to 21-8 serve as root complexes (RCs) operable as a host, and a device mounted on the PCIe bridge controller 3 serves as an endpoint (EP), to transfer data between the host and the device.

The processors 21-1 to 21-8 may be provided by different manufacturers or vendors. For example, it is assumed that the processors 21-1, 21-2, 21-3, 21-4, 21-5, 21-6, 21-7, and 21-8 be provided by A company, B company, C company, D company, E company, F company, G company, and H company, respectively.

Hereinafter, the processors 21-1, 21-2, 21-3, 21-4, 21-5, 21-6, 21-7, and 21-8 may be referred to as processors A, B, C, D, E, F, G, and H, respectively. Different platforms may be connected to the EPs mounted on the PCIe bridge controller 3. Two or more EPs may be connected to one platform, and the platform may use two or more RCs to communicate with the PCIe bridge controller 3.

Hereinafter, the processors are denoted by reference numerals 21-1 to 21-8 or reference numerals A to H when one of them is to be identified. Any of the processors or all of the processors are generally denoted by reference numeral 21.

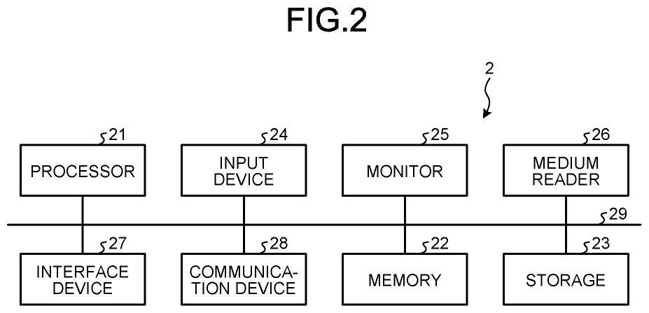

The platforms 2-1 to 2-8 serve as computer environments for computations such as AI processing and image processing. FIG. 2 is a schematic diagram illustrating a hardware configuration of the platform 2 in the information processing system 1.

As illustrated in FIG. 2, the platform 2 includes a memory 22 that temporarily stores various types of information and a storage 23. The platform 2 includes a processor 21 that executes various computations, an input device 24 that receives data input, and a monitor 25. The platform 2 further includes a medium reader 26 that reads programs from a storage medium, an interface device 27 that connects to various devices, and a communication device 28 that connects to other information processing devices via wire or wirelessly. The elements 21 to 28 are connected to a bus 29.

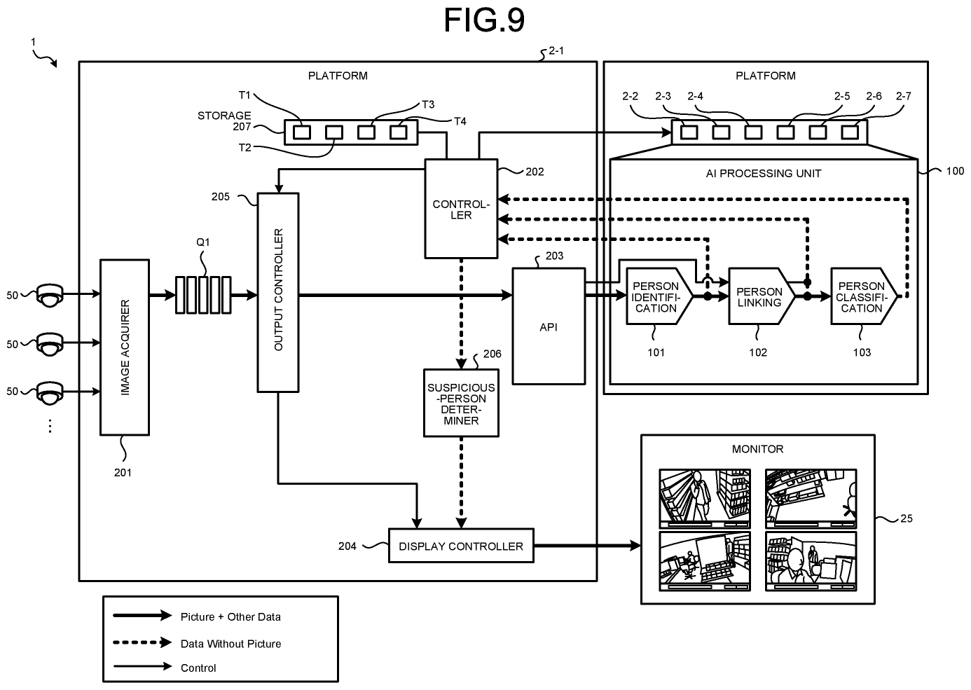

The input device 24 receives, for example, various kinds of information such as operation information from the administrator of the platform 2. The monitor 25 displays, for example, various screens such as a display screen. The interface device 27 is connected to, for example, a plurality of cameras 50, e.g., surveillance cameras in FIG. 9, or a printer. The cameras 50 serve as data generators that generate image data. The data generators are not limited to the cameras 50, and they may be other devices that generate data, for example, a microphone that generates audio data.

The memory 22 serves as a storage device including a read only memory (ROM) and a random access memory (RAM). The ROM of the memory 22 contains various software programs and data for use by such programs. The processor 21 reads and executes the software programs from the memory 22 when appropriate. The processor 21 uses the RAM of the memory 22 as a primary memory or a working memory.

The storage 23 represents a storage device such as a hard disk drive (HDD), a solid state drive (SSD), a storage class memory (SCM) and stores various kinds of data. The storage 23 stores various software programs.

The processor 21 serves to control the entire platform 2. The processor 21 may be a multi-processor. The processor 21 may be, for example, any one of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). In addition, the processor 21 may be a combination of two or more among a CPU, an MPU, a GPU, a DSP, an ASIC, a PLD, and an FPGA.

In the platform 2, the processor 21 implements various functions by executing software programs stored in the memory 22 and the storage 23.

The various software programs as above may not be stored in the memory 22 or the storage 23. For example, the platform 2 may read and execute a program from a storage medium readable by the medium reader 26 of the platform 2. Examples of the storage medium readable by the platform 2 include a CD-ROM, a DVD disk, a portable recording medium such as a universal serial bus (USB) memory, and a semiconductor memory such as a flash memory or a hard disk drive. Such information processing programs may be stored in devices connected to a public network, the Internet, or a LAN, and the platform 2 may read and execute the information processing programs from the devices.

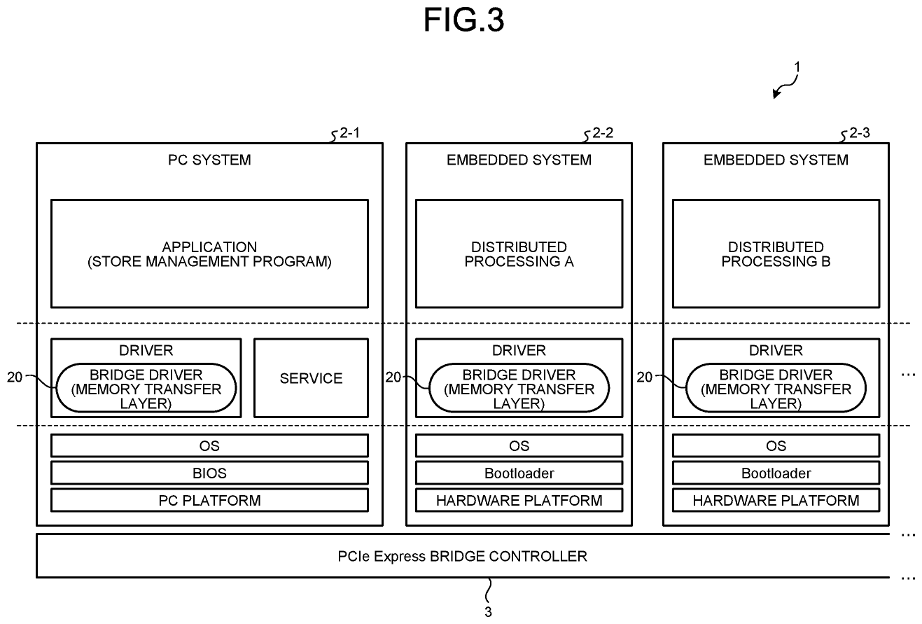

FIG. 3 is a diagram illustrating a software configuration of the platform 2 in the information processing system 1. FIG. 3 illustrates the software configuration of the platforms 2-1 to 2-3 alone for the sake of convenience.

In the information processing system 1 illustrated in FIG. 3, the platform 2-1 serves as a general personal computer (PC) system, and uses Windows (registered trademark) as an operating system (OS). The platform 2-1 executes a store management program as an application on the OS.

The platforms 2-2 and 2-3 are embedded systems. Each of the platforms uses Linux (registered trademark) as an OS, for example. The platforms 2-2 and 2-3 execute a distributed processing program for AI processing on the OS.

Each platform 2 includes a bridge driver 20. The platform 2 communicates with the PCIe bridge controller 3 and the other platforms 2 via the bridge driver 20. The communication method of the bridge driver 20 will be described later.

Each platform 2 includes a processor 21 and a memory (physical memory) 22, and the processor 21 implements the respective functions by executing the OS, various programs, and drivers stored in the memory 22.

As described above, the processors 21 of the respective platforms 2 may be provided by different vendors. In the example of FIG. 1, at least part (for example, the platform 2-7) of the platforms 2 may be a platform (for example, x86 processor manufactured by Intel Corporation) including a plurality of RCs.

Each platform 2 is independently operable so as not to affect the other driver elements.

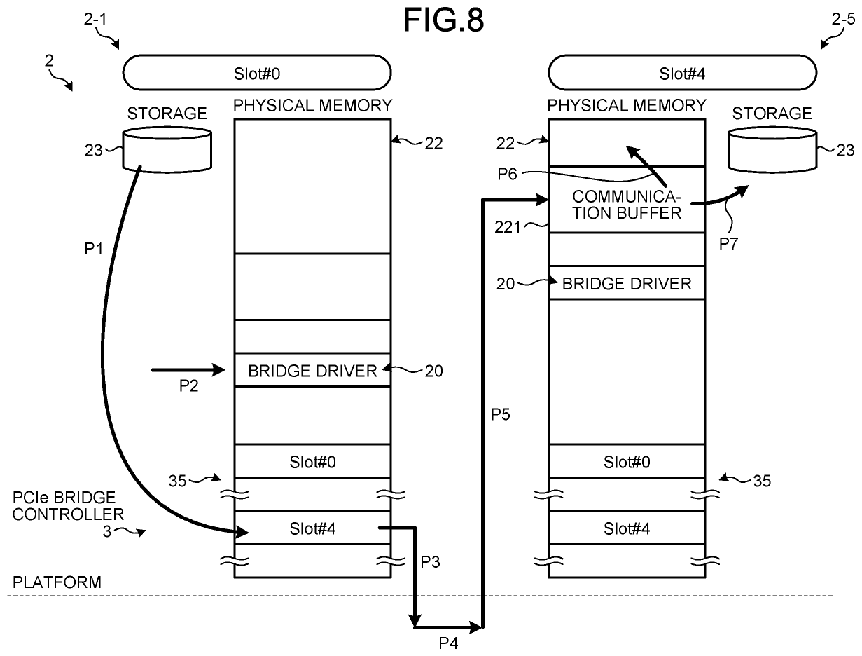

In the platform 2, part of the storage area of the memory 22 is used as a communication buffer that temporarily stores data to be transferred between the platforms 2, i.e., the processors 21, as described later with reference to FIG. 8.

PCIe Bridge Controller

The PCIe bridge controller 3 implements data communications among the platforms 2-1 to 2-8.

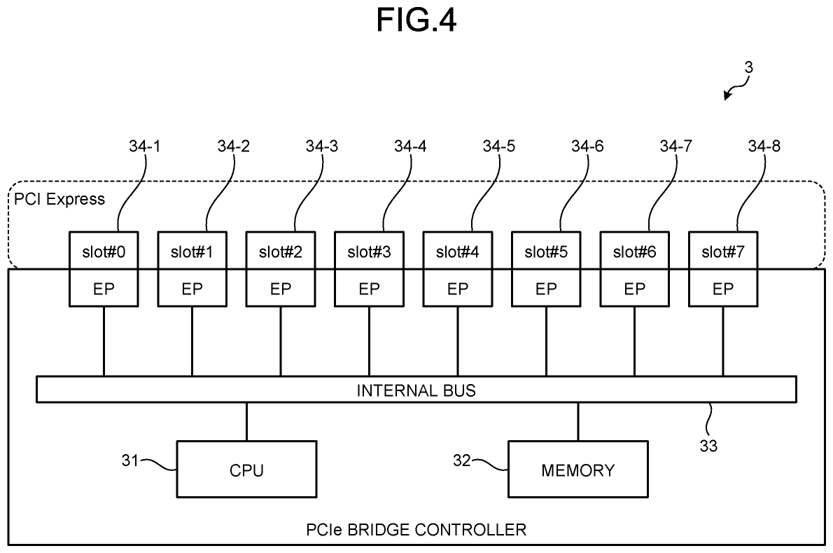

FIG. 4 is a schematic diagram illustrating a hardware configuration of the PCIe bridge controller 3 in the information processing system 1.

The PCIe bridge controller 3 represents, for example, a relay device including eight-channel EPs in one chip. As illustrated in FIG. 4, the PCIe bridge controller 3 includes a CPU 31, a memory 32, an internal bus 33 (interconnect bus), and a plurality (eight in the example of FIG. 4) of slots 34-1 to 34-8.

The respective slots 34-1 to 34-8 are connected to devices that satisfy the PCIe standard. Specifically, in the information processing system 1, the platforms 2 are connected to the slots 34-1 to 34-8, respectively.

Hereinafter, the slots are denoted by the reference numerals 34-1 to 34-8 when one of them is to be identified. Otherwise, any of the slots or all the slots are generally denoted by a reference numeral 34.

As the platforms 2-1 to 2-8, the platforms 2 may be connected to the slots 34 one by one, however, the present embodiment is not limited thereto. One platform 2 may be connected to a plurality of (for example, two) slots 34. The connection form of the platforms 2 may be variously modified.

By allocating two or more slots 34 to each platform 2, the platforms 2 can perform communication in a wider communication band.

Each slot 34 is connected to the internal bus 33. The CPU 31 and the memory 32 are connected to the internal bus 33. That is, the slots 34, the CPU 31, and the memory 32 are communicably connected to each other via the internal bus 33.

The memory 32 is, for example, a storage device (physical memory) including a ROM and a RAM. The ROM of the memory 32 contains a software program for data communication control and data for use by such a program. The CPU 31 reads and executes the software program from the memory 32 as appropriate. The RAM of the memory 32 is used as a primary memory or a working memory.

The PCIe bridge controller 3 further includes a register 35 (memory area in FIG. 8) corresponding to each slot. In a base address register (BAR) space of the register 35, a storage area is provided for each slot. That is, the BAR space of the register 35 includes the storage areas corresponding to the Slot #0 to Slot #7.

The PCIe bridge controller 3 transfers data among the platforms 2 using a storage area for each slot in the BAR space, as described later.

The CPU 31 controls the entire PCIe bridge controller 3. The CPU 31 may be a multi-processor. The CPU 31 may be replaced by any one of an MPU, a GPU, a DSP, an ASIC, a PLD, and an FPGA. The CPU 31 may be a combination of two or more among a CPU, an MPU, a GPU, a DSP, an ASIC, a PLD, and an FPGA.

Then, the PCIe bridge controller 3 transfers data among the platforms 2, i.e., the processors 21 by the CPU 3's executing the software program stored in the memory 32.

The PCIe bridge controller 3 employs the PCIe in order to speed up the data transfer among the platforms 2. The PCIe bridge controller 3 allows the processors 21 in the respective platforms 2 to operate as RCs, as illustrated in FIG. 1, to transfer data among the EPs operating as devices.

Specifically, in the information processing system 1, the processor 21 of each platform 2 operates as an RC of the PCIe serving as a data transfer interface. The PCIe bridge controller 3, that is, the slot 34 connected to each platform 2 operates as an EP with respect to each platform 2 (processor 21).

Connecting the PCIe bridge controller 3 to the processors 21 as EPs can be implemented by various known methods.

For example, the PCIe bridge controller 3 connects to the processor 21 as an EP by transmitting to the processor 21 a signal indicating that the PCIe bridge controller 3 functions as an EP.

The PCIe bridge controller 3 tunnels data from endpoint to endpoint (EP to EP), to transfer the data to the RCs. For communication, the processors 21 are logically connected when transaction occurs on the PCIe, and the processors 21 can transfer data in parallel unless data transfer concentrates on one processor 21.

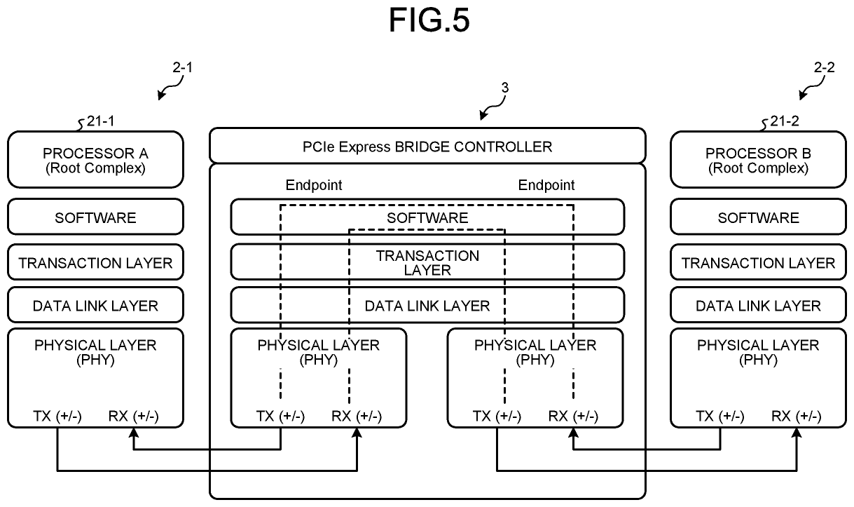

FIG. 5 is a diagram illustrating a layer configuration of the PCIe. FIG. 5 illustrates an example that the processor A of the platform 2-1 and the processor B of the platform 2-2 communicate with each other.

In the platform 2-1 as a transmission source, the processor A as an RC generates data. The data is sequentially transferred to software, a transaction layer, a data link layer, and a physical layer (PHY), and in the physical layer the data is transferred to the physical layer of the PCIe bridge controller 3.

In the PCIe bridge controller 3, the data is sequentially transferred to a physical layer, a data link layer, a transaction layer, and a software, and then transferred to the EP corresponding to the RC of the platform 2 of a destination by tunneling.

That is, in the PCIe bridge controller 3, data is transferred from one RC (processor 21) to another RC (processor 21) by tunneling the data between EPs.

In the platform 2-2 of the transmission destination, the data transferred from the PCIe bridge controller 3 is sequentially transferred to the physical layer (PHY), the data link layer, the transaction layer, and the software, and then transferred to the processor B of the platform 2-2 of the transmission destination.

In the information processing system 1, the processors 21 (the platforms 2) are logically connected for communication when a transaction occurs on the PCIe.

Any sets of the processors 21 may transfer data in parallel unless data transfer from the other processors 21 concentrates on a specific processor 21 connected to one of the eight slots of the PCIe bridge controller 3.

For example, when the processor B of the platform 2-2 and the processor C of the platform 2-3 both intend to communicate with the processor A of the platform 2-1, the PCIe bridge controller 3 processes the communications with the processors B and C serially.

However, the PCIe bridge controller 3 processes the communications between the processors 21 in parallel while different pairs of processors, such as processor A and processor B, processor C and processor D, and processor E and processor F, communicate with each other and no concentration of communication occurs on a specific processor.

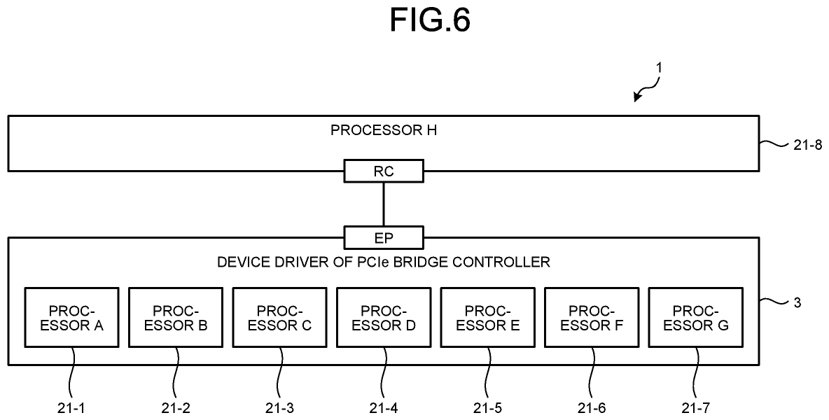

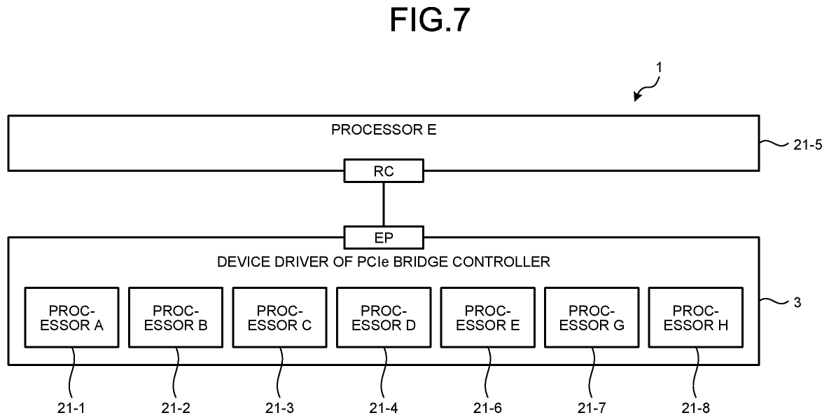

FIG. 6 is a diagram illustrating how the other processors 21 appear from the processor 21-8 (processor H) in the information processing system 1. FIG. 7 is a diagram illustrating how the other processors 21 appear from the processor 21-5 (processor E).

While all the processors 21 perform communication with one another, the OS on each processor 21, such as a Windows device manager, sees the PCIe bridge controller 3 alone, so that the OS is not to directly manage the other processor 21 connected. That is, the device driver of the PCIe bridge controller 3 can manage the processor 21 initially connected to the PCIe bridge controller 3.

This leads to eliminating the necessity to prepare device drivers for operating the processors 21 serving as the transmission source and destination. The driver of the PCIe bridge controller 3 can perform communication processing to the PCIe bridge controller 3 alone, to enable communications among the processors 21.

Data Transfer Method Among Processors

The following will describe data transfer among the processors 21 through the PCIe bridge controller 3 in the information processing system 1.

FIG. 8 is a diagram illustrating a data transfer method between the processors 21 through the PCIe bridge controller 3 in the information processing system 1. In the example of FIG. 8, data is transferred from the platform 2-1 connected to the Slot #0 to the platform 2-5 connected to the Slot #4.

The platform 2-1 being a data transmission source receives data (hereinafter, sometimes referred to as transmit data) transmitted by a software program and stores the data in the register 35 of the platform 2-1 from the storage 23 (refer to reference numeral P1). The register 35 may be part of the communication buffer. The register 35 refers to an area of each platform 2 in the same size as the memory 22. The register 35 is divided by the number of the slots. The divided storage areas of the register 35 are associated with the slots one by one. In the register 35, for example, a storage area denoted by Slot #0 is associated with the platform 2-1 connected to the Slot #0, and a storage area denoted by Slot #4 is associated with the platform 2-5 connected to the Slot #4. The platform 2-1 stores transmit data in an area (herein, Slot #4) of the register 35 allocated to the slot of the transmission destination.

The platform 2-1 being the transmission source acquires or generates slot information indicating the slot of the transmission destination and address information indicating an address in the divided area of the register 35 of the transmission destination, on the basis of the storage area of the register 35 of the platform 2-1 (refer to reference numeral P2).

The platform 2-1 being the transmission source transmits transfer data including the slot information, the address information, and the transmit data to the PCIe bridge controller 3 (refer to reference numeral P3). As a result, the PCIe bridge controller 3 connects the slot of the transmission source and the slot of the transmission destination from EP to EP on the basis of the slot information, to transfer the transfer data to the platform 2-5 being the transmission destination (refer to reference numeral P4).

On the basis of the slot information and the address information, the platform 2-5 being the transmission destination stores the transmit data or the transfer data in the area at the address designated by the address information in the storage area corresponding to the communication buffer 221 of the platform 2-5 (refer to reference numeral P5).

In the platform 2-5 being the transmission destination, for example, the program reads the transmit data from the communication buffer 221 and transfers the transmit data to the memory (local memory) 22 or the storage 23 (refer to reference numerals P6 and P7).

As described above, the data (transfer data) is transferred from the platform 2-1 being the transfer source to the platform 2-5 being the transfer destination.

Thus, in the information processing system 1, the EPs of the PCIe bridge controller 3 serve to mediate data transfer. Thereby, the data transfer among the RCs (processors 21) connected to the PCIe bridge controller 3 can be implemented.

That is, the processors 21 operate independently as a PCIe RC, and the PCIe bridge controller 3 connects each processor 21 to a device as an EP to perform data transfer among the EPs. This makes it possible to avoid inconvenience caused by the device driver and the processors 21 can transfer data at higher speed, operating as one system.

Further, the different processors 21 can transfer data to each other as long as they include a data communication function conforming to the PCIe standard. This makes it possible to increase options of processors 21 for use without considering presence or absence of a device driver or a supported OS.

The processor 21 are mutually connected via the PCIe bridge controller 3 serving as an EP, which eliminates the need to add a device driver of an RC ahead of the EP. This makes it unnecessary to develop a device driver. No failures or malfunction will arise, which would otherwise occur from addition of the device driver.

Characteristic Functions of Information Processing System 1

Next, among the functions implemented by the processors 21 by the OS and the software programs installed in the storages 23 of the platforms 2-1 to 2-7, the characteristic functions of the information processing system 1 according to the present embodiment will be described.

FIG. 9 is a functional block diagram illustrating the functions of the information processing system 1. FIG. 9 omits depicting the PCIe bridge controller 3. In FIG. 9 major data flows are indicated by the arrows, and data exchange occurs as appropriate even if not indicated by the arrows.

Conventionally, data processing by multiple processors as hardware to share multiple kinds of tasks to data output from a data generator is available. Recently, various services become available through artificial intelligence (AI) processing such as object recognition using deep learning technology as machine learning. In the following, multiple kinds of tasks are exemplified by individual AI processes of the AI processing.

Herein, among the platforms 2-1 to 2-7, the platforms 2-2 to 2-7 execute a distributed processing program for the AI processing to monitor a retail premise by machine learning, specifically, deep learning.

As illustrated in FIG. 9, the platforms 2-2 to 2-7 implement an AI processing unit 100. The AI processing unit 100 performs AI processing, such as person recognition by deep learning, to the image data from the cameras 50. More specifically, the AI processing unit 100 executes AI processing such as person identification, person linking, and person classification in a distributed manner for surveillance of a store or a shop.

The person identification is a process for identifying a person or part of a person, types of belongings, and detected coordinates from the image data generated by the cameras 50. One or more platforms 2 constitute a first AI processing unit 101 that handles the person identification.

The person linking is a process for linking or associating information representing an identified person with a plurality of items of time-series image data. One or more platforms 2 constitute a second AI processing unit 102 that handles the person linking.

The person classification is a process for classifying persons linked in time series. One or more platforms 2 constitute a third AI processing unit 103 that handles the person classification.

Meanwhile, the platform 2-1 serves as an exemplary information processing device connected to a plurality of processors (the processors B to G) as hardware to which one or more tasks (person identification, person linking, and person classification) are allocable, to process data (image data) output from the data generators (cameras 50). In the platform 2-1, the processor 21 (FIG. 2) implements the functions (the elements 201 to 206 in FIG. 9) by loading and executing the store management program from the storage 23 (FIG. 2) to the memory 22. As described above, the AI processing unit 100 includes the processors (herein, a total of six processors B to G in the platforms 2-2 to 2-7) as hardware that perform the processing of the AI processing unit 100.

The platform 2-1 outputs the image data generated by the cameras 50 to the platforms 2-2 to 2-7 and displays the image data on the monitor 25.

As illustrated in FIG. 9, the platform 2-1 includes an image acquirer 201, a controller 202, an application programming interface (API) 203, a display controller 204, an output controller 205, and a suspicious-person determiner 206, and a storage 207.

The image acquirer 201 acquires image data from the cameras 50, and sequentially accumulates the acquired image data in a queue Q1.

The controller 202 collectively controls the processing in the platform 2-1. The controller 202 will be described in detail later.

The API 203 serves as an interface to provide data from the platform 2-1 to the platforms 2-2 to 2-7. Specifically, the API 203 receives the image data from the output controller 205 and outputs it to the first AI processing unit 101.

The display controller 204 receives the image data from the output controller 205 for display on the monitor 25.

The output controller 205 outputs the accumulated image data in the queue Q1 to the API 203 and the display controller 204.

The controller 202 acquires results of the AI processing from the first AI processing unit 101, the second AI processing unit 102, and the third AI processing unit 103. The AI processing results are added with time stamps, for example, in a JSON (JavaScript (registered trademark) object notation) format. The suspicious-person determiner 206 determines a suspicious person on the basis of the AI processing results from the controller 202. The display controller 204 receives a result of the determination from the suspicious-person determiner 206 and displays it on the monitor 25. The controller 202 controls the output controller 205.

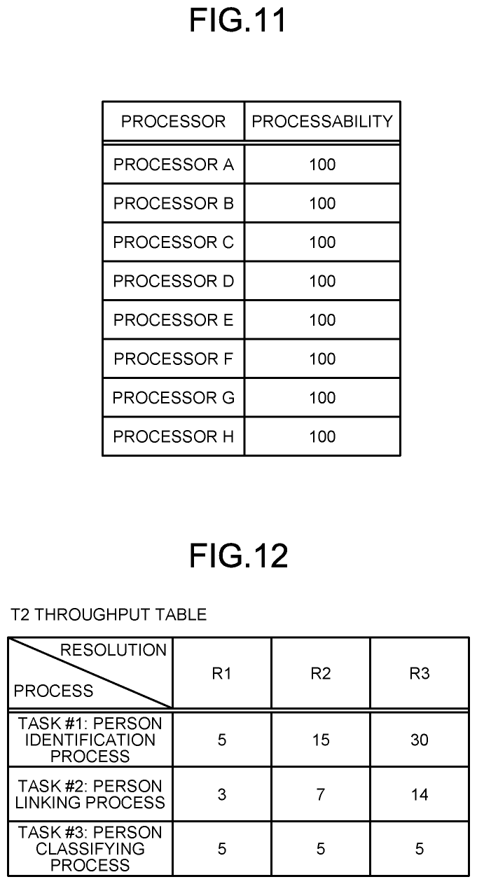

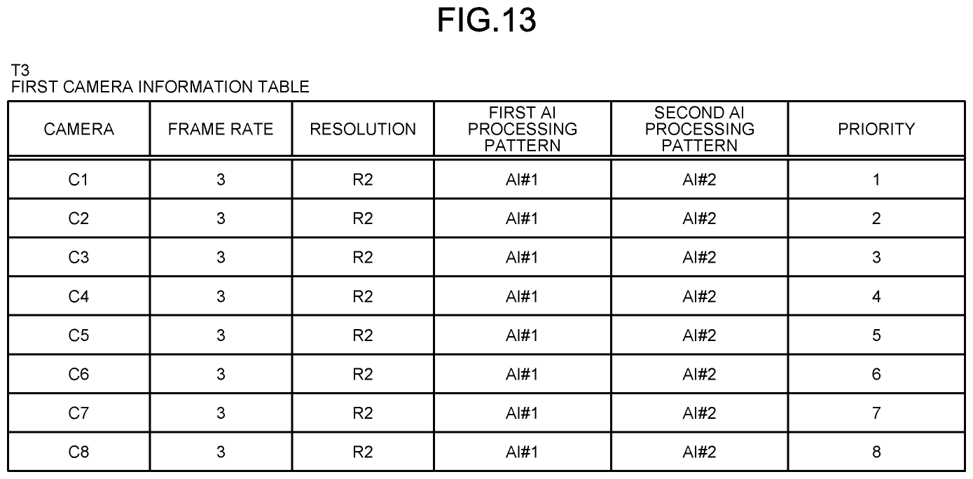

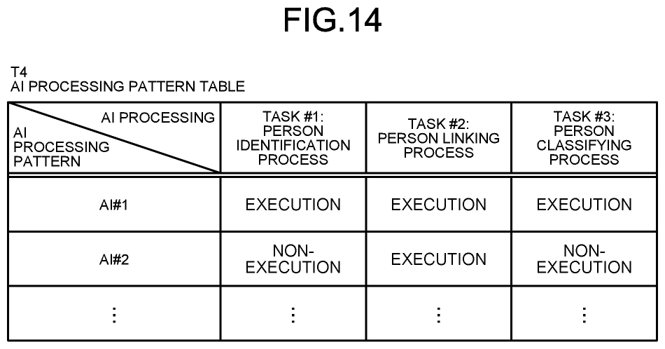

The storage 207 corresponds to, for example, the memory 22 and the storage 23 illustrated in FIG. 2. The storage 207 stores various kinds of data such as a processability table T1 (FIG. 11), a throughput table T2 (FIG. 12), a first camera information table T3 (FIG. 13), and an AI processing pattern table T4 (FIG. 14). The tables T1 to T4 will be described in detail later.

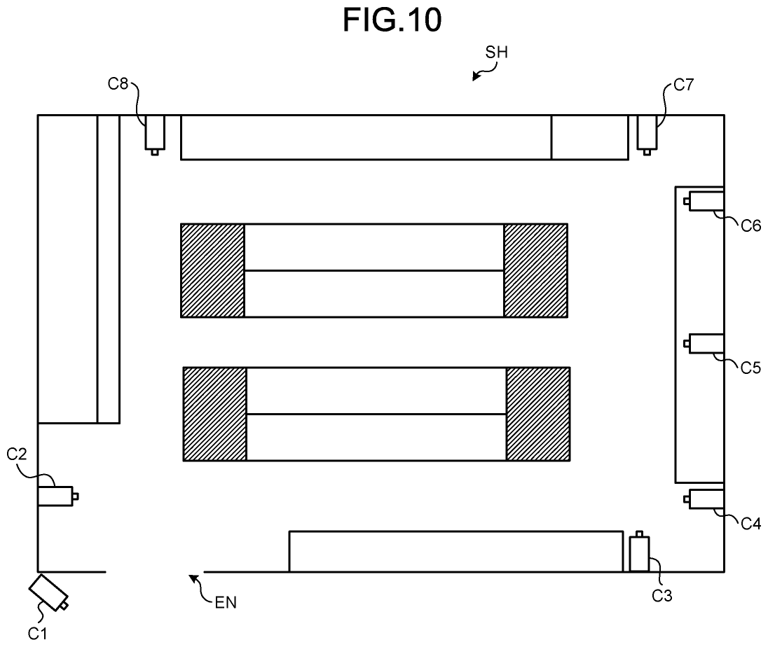

FIG. 10 is a schematic diagram of a store where the cameras 50 (FIG. 9) are installed. In FIG. 10, for the sake of convenience, the cameras 50 are denoted by C1 to C8. As illustrated in FIG. 10, the eight cameras C1 to C8 are installed in a store SH. For example, the camera C1 is located to generate an image of outside an entrance EN of the store SH.

FIG. 11 is a schematic diagram illustrating an example of the processability table T1. The processability table T1 includes exemplary information representing the processability of each of the processors. In the processability table T1, the processability per second of all the processors A to H (FIG. 1) is set to 100. In the following, all the eight cameras 50 (C1 to C8) generate image data at three frames per second (fps).

FIG. 12 is a schematic diagram illustrating an example of the throughput table T2. The throughput table T2 includes exemplary information representing the throughput for each of the tasks that process data in a predetermined unit/device. In the throughput table T2, the throughput for each of the task #1 (person identification), the task #2 (person linking), and the task #3 (person classification)) is set corresponding to each resolution (R1<R2<R3).

Specifically, with respect to resolution R1, the throughputs of the respective tasks are set to 5, 3, and 5 in order from the top. With respect to the resolution R2, the throughputs of the respective tasks are set to 15, 7, and 5 in order from the top. With respect to the resolution R3, the throughputs of the respective tasks are set to 30, 14, and 5 in order from the top.

The throughputs of the task #1 and the task #2 increase as the resolution increases. In contrast, the throughput of the task #3 is constant irrespective of the resolution.

FIG. 13 is a schematic diagram illustrating an example of the first camera information table T3. The first camera information table T3 includes exemplary information including priority set to each of the data generators. In the first camera information table T3, frame rate (fps), resolution, first AI processing pattern, second AI processing pattern, and priority are set to each of the cameras C1 to C8.

Specifically, all the frame rates are set to 3. All the resolutions are set to R2. All the first AI processing patterns are set to AI #1, as described later in FIG. 14. All the second AI processing patterns are set to AI #2 as described later in FIG. 14. The priority is set to 1 to 8 in order from the top.

FIG. 14 is a schematic diagram illustrating an example of the AI processing pattern table T4. The AI processing pattern table T4 includes exemplary information representing the processing patterns defining tasks to execute. In the AI processing pattern table T4, execution or non-execution of the task #1, the task #2, and the task #3 is set to each AI processing pattern.

Specifically, in the pattern AI #1, execution of all of the task #1, the task #2, and the task #3 are defined. In the pattern AI #2, non-execution of the task #1 and the task #3 and execution of the task #2 are defined. In the case of AI #2, the task #2 is executable without the task #1 by incorporating a simplified program of the task #1 into the program of the task #2.

Returning to FIG. 9, the controller 202 allocates one or more of the tasks to each of the processors B to G (the platforms 2-2 to 2-7), with reference to the tables T1 to T4 stored in the storage 207. In response to a change in the number of available processors, the controller 202 performs the task allocation again. The controller 202 may allocate one or more of the tasks and at least one or more items of data output from the data generators to each of the processors B to G as data to be subject of the tasks.

The controller 202 may determine one of the processing patterns for each of the data generators with reference to the tables T1 to T4, to allocate one or more of the tasks to each of the processors.

The controller 202 may determine one of the processing patterns for each of the data generators such that a larger number of tasks are to be executed to data output from the data generator with higher priority, with reference to the tables T1 to T4.

Calculation related to the allocation of tasks to the processors B to G is now described by way of example. The controller 202 performs the calculation. Referring to the first camera information table T3 in FIG. 13, the first AI processing pattern AI #1 (FIG. 14) is applied to all the cameras C1 to C8. In this case, the tasks #1 to #3 are executed for all the cameras C1 to C8.

Then, referring to the throughput table T2 in FIG. 12, the throughput required for the task #1 per second is found as 3 (fps)×8 (the number of cameras)×15 (the throughput at the resolution R2)=360. With the processability per processor at 100, the number of required processors is thus four.

The throughput required for the task #2 per second is found as 3 (fps)×8 (the number of cameras)×7 (the throughput at the resolution R2)=168. The number of required processors is thus two.

The throughput required for the task #3 per second is found as 3 (fps)×8 (the number of cameras)×5 (the throughput at the resolution R2)=120. The number of required processors is thus two.

In this case, the total number of required processors is 4+2+2=8, which is more than the number of available processors of 6 and therefore unfeasible.

Referring to the first camera information table T3 in FIG. 13, not the first AI processing pattern AI #1 (FIG. 14) but the second AI processing pattern AI #2 (FIG. 14) is applied to the camera C8 with the lowest priority among the cameras C1 to C8. In this case, the tasks #1 to #3 are executed for the cameras C1 to C7, and the task #2 is executed for the camera C8.

Then, referring to the throughput table T2 in FIG. 12, the throughput required for the task #1 per second is found as 3 (fps)×7 (the number of cameras)×15 (throughput at the resolution R2)=315. The number of required processors is thus four.

The throughput required for the task #2 per second is found as 3 (fps)×8 (the number of cameras)×7 (the throughput at the resolution R2)=168. The number of required processors is thus two.

The throughput required for the task #3 per second is found as 3 (fps)×7 (the number of cameras)×5 (the throughput at the resolution R2)=105. The number of required processors is thus two.

In this case, the total number of required processors is 4+2+2=8, which is more than the number of available processors of 6 and found as unfeasible.

In view of this, referring to the first camera information table T3 in FIG. 13, not the first AI processing pattern AI #1 (FIG. 14) but the second AI processing pattern AI #2 (FIG. 14) is applied to the camera C7 with the second lowest priority next to the camera C8. In this case, the tasks #1 to #3 are executed for the cameras C1 to C6, and the task #2 is executed for the cameras C7 and C8.

Then, referring to the throughput table T2 in FIG. 12, the throughput required for the task #1 per second is found as 3 (fps)×6 (the number of cameras)×15 (throughput at the resolution R2)=270. The number of required processors is thus three.

The throughput required for the task #2 per second is found as 3 (fps)×8 (the number of cameras)×7 (the throughput at the resolution R2)=168. The number of required processors is thus two.

The throughput required for the task #3 per second is found as 3 (fps)×6 (the number of cameras)×5 (the throughput at the resolution R2)=90. The number of required processors is thus one.

In this case, the required total number of processors is 3+2+1=6, which is the same as the number of available processors of 6 and therefore feasible.

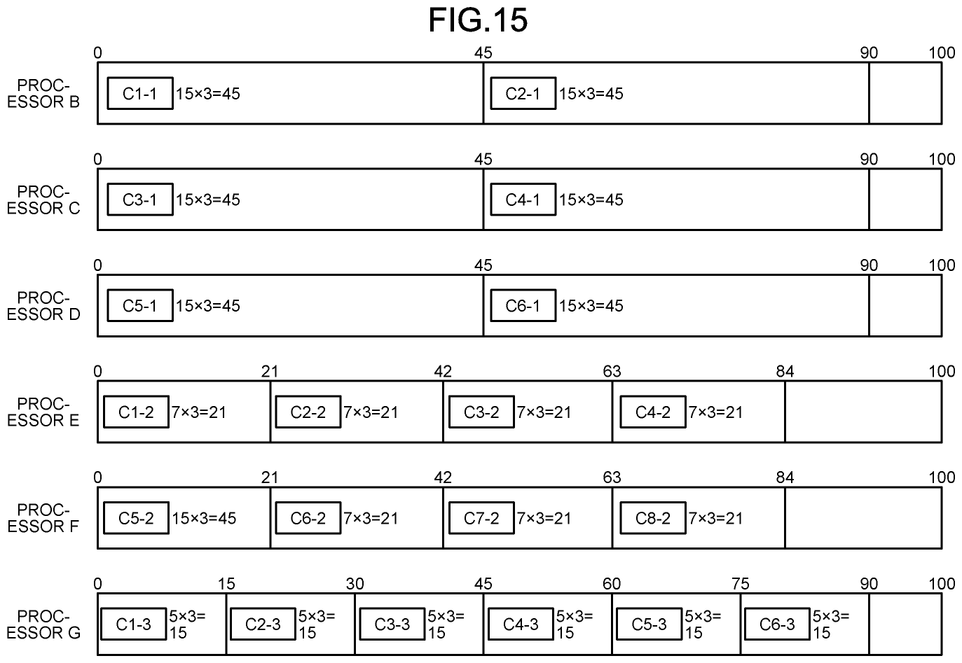

A first example of the task allocation to the processors B to G is now described. As a criterion for the allocation, for example, three-frame image data per second from each camera may be set as processing unit of one processor, and the throughput of each processor may be set in a balanced manner. FIG. 15 is a diagram illustrating the first example of the task allocation to the processors B to G. In FIG. 15, the task #1 to the data of the camera C1 is denoted by C1-1, and the same applies to the other tasks.

Tasks C1-1 and C2-1 are allocated to the processor B. Tasks C3-1 and C4-1 are allocated to the processor C. Tasks C5-1 and C6-1 are allocated to the processor D.

Tasks C1-2, C2-2, C3-2, and C4-2 are allocated to the processor E. Tasks C5-2, C6-2, C7-2, and C8-2 are allocated to the processor F. Tasks C1-3, C2-3, C3-3, C4-3, C5-3, C6-3, C7-3, and C8-3 are allocated to the processor G.

In this manner, multiple tasks can be appropriately and easily allocated to the respective processors to process the data output from the data generators in a shared manner.

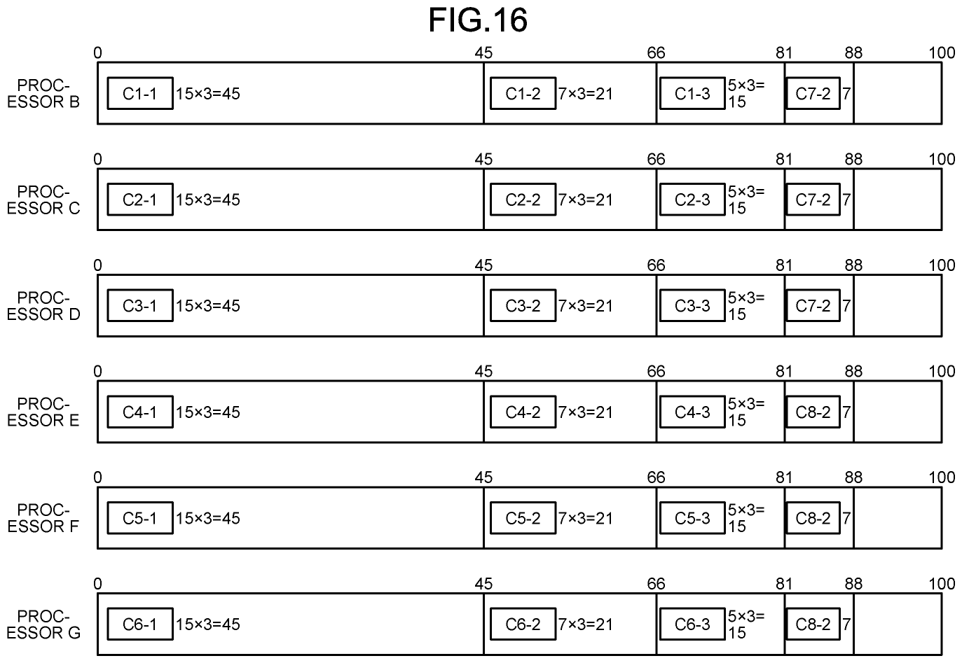

A second example of the task allocation to the processors B to G is now described. As a criterion for the allocation, for example, three-frame image data per second from each camera may be set as processing unit of one processor, and the throughput of each processor may be set in a balanced manner. FIG. 16 is a diagram illustrating the second example of the task allocation to the processors B to G.

Tasks C1-1, C1-2, C1-3, and C7-2 (one frame) are allocated to the processor B. Tasks C2-1, C2-2, C2-3, and C7-2 (one frame) are allocated to the processor C. Tasks C3-1, C3-2, C3-3, and C7-2 (one frame) are allocated to the processor D.

Tasks C4-1, C4-2, C4-3, and C8-2 (one frame) are allocated to the processor E. Tasks C5-1, C5-2, C5-3, and C8-2 (one frame) are allocated to the processor F. Tasks C6-1, C6-2, C6-3, and C8-2 (one frame) are allocated to the processor G.

In this manner, multiple tasks can be appropriately and easily allocated to the respective processors to process the data output from the data generators in a shared manner.

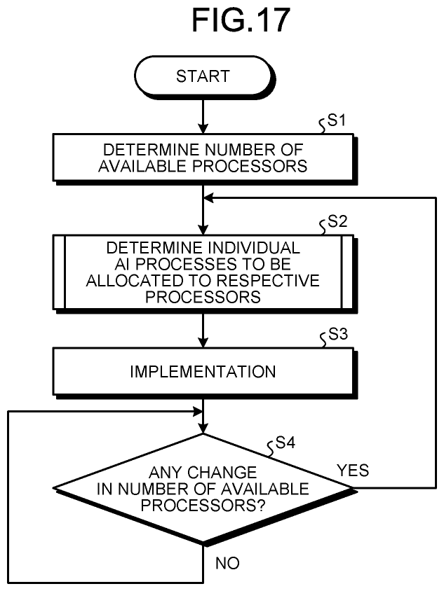

Next, the processing of the platform 2-1 being the information processing device will be described with reference to FIG. 17. FIG. 17 is a flowchart illustrating the processing in the platform 2-1 being the information processing device. Such processing is executed, for example, during configuration of the environment of the information processing system 1.

First, in Step S1, the controller 202 of the platform 2-1 (hereinafter, simply referred to as controller 202) determines the number of available processors. For example, as illustrated in FIG. 9, if the platforms 2-2 to 2-7 among the platforms 2-2 to 2-8 are available, the controller 202 sets the number of available processors to 6.

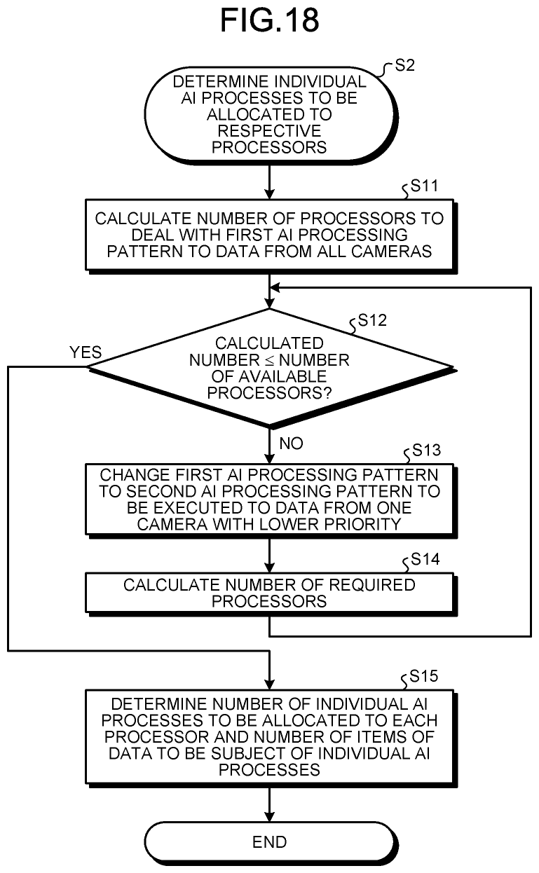

In Step S2, the controller 202 determines individual AI processes (the tasks #1 to #3) to be allocated to the respective processors B to G. FIG. 18 is a flowchart illustrating an example of the process of Step S2 of the flowchart in FIG. 17 in detail.

In Step S11, the controller 202 calculates the number of processors to deal with the first AI processing pattern AI #1 (FIG. 14) to the data from all the cameras C1 to C8.

Next, in Step S12, the controller 202 determines whether or not the number calculated in Step S11 is equal to or less than the available number set in Step S1. In the case of YES, the controller 202 proceeds to Step S15; and in the case of NO, the controller 202 proceeds to Step S13.

In Step S13, the controller 202 changes the first AI processing pattern to the second AI processing pattern AI #2 (FIG. 14) to be applied to the data from one camera with lower priority.

In Step S14, the controller 202 calculates the number of required processors under the changed condition in Step S13, and returns to Step S12.

In Step S15, the controller 202 determines the number of individual AI processes to allocate to each processor and the number of items of data to be subject of the individual AI processes (refer to FIGS. 15 and 16).

Returning to FIG. 17, in Step S3, the controller 202 allocates or implements the individual AI processes and the data to be subject of the individual AI processes to the respective processors, as determined in Step S2.

Next, in Step S4, the controller 202 determines whether the number of available processors is changed. In the case of YES, the controller 202 returns to Step S2; in the case of NO, the controller 202 returns to Step S4. The number of available processors may be changed, for example, due to a failure of the processor or extraction of the processor for maintenance purpose.

Thus, in the information processing system 1 of the first embodiment, to share the tasks #1 to #3 to the image data output from the cameras 50 among the processors B to G, the platform 2-1 being the information processing device can appropriately and easily allocate the tasks to the respective processors with reference to the tables T1 to T4. The platform 2-1 can specifically allocate one or more items of data being subject of the tasks to the respective processors in addition to the task allocation (refer to FIGS. 15 and 16).

Further, the platform 2-1 can appropriately and easily allocate the tasks to the respective processors referring to the first camera information table T3, on the premise that the data from all the cameras C1 to C8 are subjected to the tasks. Specifically, the first AI processing pattern AI #1 to the data of all the cameras C1 to C8 is calculated first. With the number of available processors found to be insufficient, the platform 2-1 changes the first AI processing pattern AI #1 to the second AI processing pattern AI #2 for recalculation in order from the camera with the lowest priority among the cameras C1 to C8. The platform 2-1 can execute the AI processing to the data from all the cameras C1 to C8, which is particularly effective, for example, for flow line analysis in a store.

With a change in the number of available processors, the platform 2-1 can continue to allocate the individual AI processes to the processors appropriately by determining the individual AI processes to allocate again.

### Second Embodiment

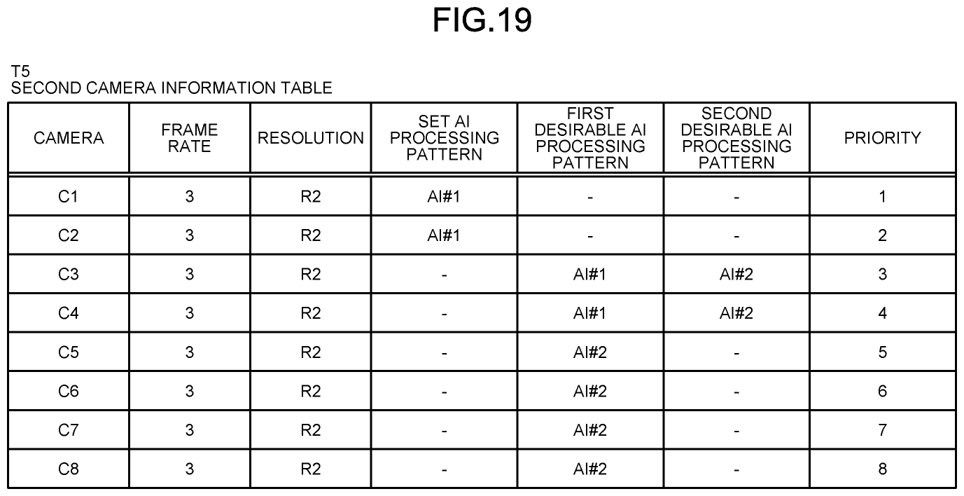

Next, a second embodiment will be described. Overlapping description of the same or similar contents as in the first embodiment will be omitted as appropriate. The second embodiment is different from the first embodiment in using a second camera information table T5 (FIG. 19) instead of the first camera information table T3 (FIG. 13).

FIG. 19 is a schematic diagram illustrating an example of the second camera information table T5 in the second embodiment. The second camera information table T5 includes exemplary information representing priority set to each of the data generators. In the second camera information table T5, frame rate (fps), resolution, set AI processing pattern, first desirable AI processing pattern, second desirable AI processing pattern, and priority are set for each of the cameras C1 to C8.

Specifically, all the frame rates are set to 3. All the resolutions are set to R2.

The set AI processing pattern, AI #1 (FIG. 14) is set to the cameras C1 and C2 but is not set to the cameras C3 to C8. This indicates that the pattern AI #1 (FIG. 14) is necessary setting to the cameras C1 and C2. Specifically, for example, the area imaged by the cameras C1 and C2 may be an important area such as an entrance or an expensive-goods selling section of a store.

The first desirable AI processing pattern is not set to the cameras C1 and C2, the pattern AI #1 (FIG. 14) is set to the cameras C3 and C4, and the pattern AI #2 (FIG. 14) is set to the cameras C5 to C8.

The second desirable AI processing pattern is not set to the cameras C1 and C2, the pattern AI #2 (FIG. 14) is set to the cameras C3 and C4 and is not set to the cameras C5 to C8.

The priority is set to 1 to 8 in order from the top.

The controller 202 of the platform 2-1 allocates one or more of the tasks to each of the processors by determining a processing pattern including a larger number of tasks among the processing patterns for each of the data generators in order from the one with the highest priority, on the basis of the tables T1, T2, T4, and T5.

That is, unlike the first embodiment, the second embodiment does not assume execution of the tasks to the data from all the cameras C1 to C8. Specifically, the controller 202 determines, for the cameras C1 to C8, the processing pattern of a larger number of tasks within the range set in the second camera information table T5 in order from the camera with the highest priority. Cameras with lower priority among the cameras C1 to C8 may be not subjected to the AI processing.

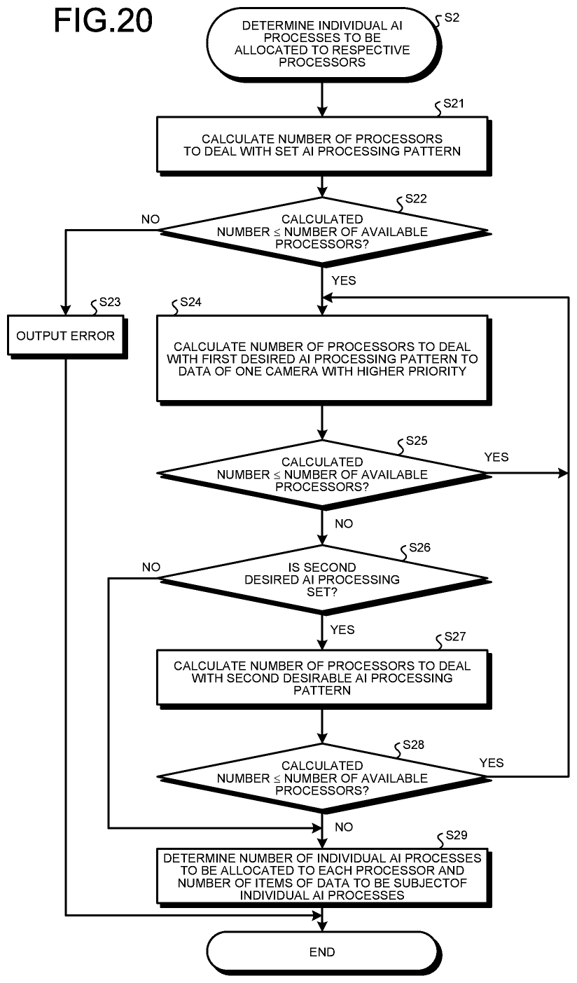

Next, the process in Step S2 of the flowchart in FIG. 17 will be described in detail with reference to FIG. 20. FIG. 20 is a flowchart illustrating an example of the process of Step S2 in the flowchart of FIG. 17 in detail.

In Step S21, the controller 202 calculates the number of processors to deal with execution of the set AI processing pattern AI #1 (FIGS. 14 and 19) to the cameras C1 and C2.

Next, in Step S22, the controller 202 determines whether or not the number calculated in Step S21 is equal to or less than the available number determined in Step S1. In the case of YES, the controller 202 proceeds to Step S24; in the case of NO, the controller 202 proceeds to Step S23.

In Step S23, the controller 202 outputs error, completing the processing. The controller 202 outputs error because the set AI processing pattern being inexecutable signifies that the settings of the second camera information table T5 (FIG. 19) are likely to be inappropriate. In this case, the administrator may change the settings of the second camera information table T5 (FIG. 19) in response to the error output, to allow the controller 202 to execute the processing of the flowchart in FIG. 20 again.

In Step S24, the controller 202 calculates the number of processors to deal with execution of the first desirable AI processing pattern to the data from one camera with higher priority among the rest of the cameras, by referring to the second camera information table T5 (FIG. 19).

Next, in Step S25, the controller 202 determines whether or not the number calculated in Step S24 is equal to or less than the available number determined in Step S1. In the case of YES, the controller 202 returns to Step S24; in the case of NO, the controller 202 proceeds to Step S26.

In Step S26, the controller 202 determines whether or not the second desirable AI processing pattern is set, referring to the second camera information table T5 (FIG. 19). In the case of YES, the controller 202 proceeds to Step S27; in the case of NO, the controller 202 proceeds to Step S29.

In Step S27, the controller 202 calculates the number of processors to deal with the second desirable AI processing pattern.

Next, in Step S28, the controller 202 determines whether or not the number calculated in Step S27 is equal to or less than the available number determined in Step S1. In the case of YES, the controller 202 returns to Step S24; in the case of NO, the controller 202 proceeds to Step S29.

In Step S29, the controller 202 sets the number of individual AI processes to allocate to each processor and the number of items of data to be subject of the individual AI processes.

Thus, the second embodiment can exert the following functions and effects in addition to those of the first embodiment. The second embodiment does not assume execution of the tasks to the data of all the cameras C1 to C8 as in the first embodiment, but preferentially executes the set AI processing pattern. This can ensure execution of the set AI processing pattern.

For example, the second embodiment can ensure the execution of the desirable AI processing pattern (for example, AI #1) to the data from the camera capturing an important area such as an entrance or an expensive-goods selling section of a store, which can work as particularly effective shoplifting measures, for example.

This disclosure is not limited to the above embodiments and can be variously modified and carried out without departing from the scope of the embodiments. The configurations or elements and the processes of the embodiments can be selected as needed or can be appropriately combined.

For example, in the configuration of FIG. 4, the PCIe bridge controller 3 includes the eight slots 34-1 to 34-8, but the PCIe bridge controller 3 is not limited thereto, and may be variously modified. That is, the PCIe bridge controller 3 may include seven or less or nine or more slots 34.

The above embodiments have described the PCIe as an example of an input/output (I/O) interface for the respective elements. However, the I/O interface is not limited to the PCIe. For example, the I/O interface for the respective elements may be any interface that enables data transfer between a device (peripheral controller) and processors via a data transfer bus. The data transfer bus may be a general-purpose bus that can transfer data at higher speed in a local environment (for example, one system or device) inside one housing. The I/O interface may be either a parallel interface or a serial interface.

The I/O interface may be point-to-point connectable and be able to serially transfer data on a packet basis. In the case of serial transfer, the I/O interface may include a plurality of lanes. The layer structure of the I/O interface may include a transaction layer for packet generation and decoding, a data link layer for error detection, and a physical layer for serial and parallel conversion. The I/O interface may include a root complex at the top hierarchy with one or more ports, an endpoint being an I/O device, a switch for increasing the number of ports, and a bridge for converting a protocol, for example. The I/O interface may serve to multiplex data to transmit and the clock signal with a multiplexer for transmission. In this case, the receive side may demultiplex the data and the clock signal with a demultiplexer.

For example, as to the AI processing at the resolution R2 in the throughput table T2 illustrated in FIG. 12, in response to a decrease in the number of available processors, the resolution R2 may be changed to the resolution R1, to be able to execute the AI processing to the data from all the cameras 50. In this case, the number of processors to deal with the AI processing can be calculated in the same manner as in the above embodiments, simply by changing the resolution R2 to the resolution R1.

The above embodiments have described the platform 2-1 as an example of the information processing device that determines the allocation of the processors, in using the platforms 2-2 to 2-7 for the individual AI processes, however, they are not limited thereto. For example, one of the platforms 2-2 to 2-7 or the platform 2-8 may operate as the information processing device.

For example, the throughput information in the throughput table T2 (FIG. 12) may be manually set by the administrator or may be automatically set from a result of executing the tasks (individual AI processes) in a test mode.

According to one aspect of this disclosure, it is possible to appropriately, easily allocate multiple tasks to a plurality of processors to process data output from a data generator in a shared manner.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing device that is connected to a plurality of processors to which one or more of a plurality of kinds of tasks are allocable, the kinds of tasks being for processing data output from a data generator, the information processing device comprising
a controller that:
allocates one or more of the kinds of tasks to each of the processors based on processability information and throughput information, the processability information representing processability of each of the processors, the throughput information representing throughput for each of the kinds of tasks to process the data in a predetermined unit.

2. The information processing device according to claim 1, wherein
the controller allocates one or more of the kinds of tasks again in response to a change in the number of the processors that are available.

3. The information processing device according to claim 1, wherein
the controller allocates, to each of the processors, one or more of the kinds of tasks, and at least one or more items of data to be subject of the one or more of the kinds of tasks among a plurality of items of data output from a plurality of data generators, based on the processability information and the throughput information.

4. The information processing device according to claim 3, wherein
the controller determines one of processing patterns for each of the data generators based on the processability information, the throughput information, and processing pattern information, to allocate one or more of the kinds of tasks to each of the processors, the processing pattern information representing the processing patterns that define kinds of tasks to be executed among the kinds of tasks.

5. The information processing device according to claim 4, wherein
the controller determines one of the processing patterns for each of the data generators based on priority information set to each of the data generators, such that a larger number of kinds of tasks are executed to the data from the data generators with higher priority.

6. The information processing device according to claim 3, wherein
the controller determines a processing pattern including a larger number of kinds of tasks among the processing patterns for the data generators in order starting from the data generator with highest priority based on the processability information, the throughput information, processing pattern information, and priority information set to each of the data generators, to allocate one or more of the kinds of tasks to each of the processors, the processing pattern information representing the processing patterns that define kinds of tasks to be executed among the kinds of tasks.

7. The information processing device according to claim 1, wherein
the kinds of tasks serve as individual artificial intelligence processes constituting artificial intelligence processing.

8. An information processing system, comprising:
a plurality of processors to which one or more of a plurality of kinds of tasks are allocable, the kinds of tasks being for processing data output from a data generator; and
an information processing device that is connected to the processors, wherein
the information processing device comprises a controller that:
allocates one or more of the kinds of tasks to each of the processors based on processability information and throughput information, the processability information representing processability of each of the processors, the throughput information representing throughput for each of the kinds of tasks to process the data in a predetermined unit.

9. The information processing system according to claim 8, wherein
the controller allocates one or more of the kinds of tasks again in response to a change in the number of the processors that are available.

10. A computer program product including programmed instructions embodied in and stored on a non-transitory computer readable medium, wherein the instructions are executed by a computer serving as an information processing device that is connected to a plurality of processors to which one or more of a plurality of kinds of tasks are allocable, the kinds of tasks being for processing data output from a data generator, the instructions causing the computer to execute:
allocating one or more of the kinds of tasks to each of the processors based on processability information and throughput information, the processability information representing processability of each of the processors, the throughput information representing throughput for each of the kinds of tasks to process the data in a predetermined unit.

11. The computer program product according to claim 10, wherein
the instructions cause the computer to allocate one or more of the kinds of tasks again in response to a change in the number of the processors that are available.
